(19) United States
(12) Patent Application Publication
(10) Pub. No.: US 2001/0020070 A1
(43) Pub. Date: Sep. 6, 2001

(54) Water-soluble polymers based on acrylic or methacrylic derivatives

(76) Inventors: Thomas Gross, Heiligenhaus (DE); Siegfried Korte, Odenthal (DE); Rolf-Volker Meyer, Much (DE); Hans-Jorg Seiler, Leverkusen (DE)

Correspondence Address: BAYER CORPORATION, PATENT DEPARTMENT, 100 BAYER ROAD, PITTSBURGH, PA, 15205, US

(21) Appl. No.: 09/776,272

(22) Filed: Feb. 1, 2001

(30) Foreign Application Priority Data
Feb. 7, 2000 (DE) 10005279.7

(51) Int. Cl. C08F 8/12; C08F 120/44; C08F 220/44; C08F 8/14; C08F 20/44

(52) U.S. Cl. 525/329.1; 525/329.2; 525/330.6; 525/362; 525/380; 525/384

(57) ABSTRACT

Water-soluble homo- and/or copolymers containing alkali metal and/or alkaline earth metal carboxylate groups and based on acrylic or methacrylic derivatives, and corresponding water-soluble homo- and/or copolymers containing carboxyl groups and homo- and/or copolymers containing ammonium carboxylate groups are provided, which homo- and/or copolymers possess excellent suitability for increasing the viscosity of aqueous systems, in particular of print pastes for textile treatment.

The invention relates to water-soluble homo- and/or copolymers containing alkali metal and/or alkaline earth metal carboxylate groups and based on acrylic or methacrylic derivatives and corresponding water-soluble homo- and/or copolymers containing carboxyl groups and homo- and/or copolymers containing ammonium carboxylate groups, the preparation thereof in each case, the use thereof for increasing the viscosity of aqueous systems, print pastes prepared therefrom, processes for textile treatment with these print pastes and the correspondingly treated textiles.

Synthetic thickeners for textile printing are known. They are usually prepared by so-called inverse emulsion polymerization, i.e. a water-in-oil polymerization (EP-A-0 721 959, DE-A-44 35 425, WO-A-92/13912, DE-A-41 23 049, DE-A-37 30 781 and DE-A-36 41 700). In rare cases, thickeners for textile printing are also prepared by a standard emulsion polymerization, i.e. an oil-in-water polymerization (WO-A-96/35757).

For example, monoethylenically unsaturated C₃- to C₅-carboxylic acids and the amides or esters thereof, such as, for example, acrylic acid, methacrylic acid, maleic acid, acrylamide, methacrylamide and 2-hydroxyethyl acrylate, are used as ethylenically unsaturated monomers for such emulsion polymerizations. These monomers are generally copolymerized in suitable mixtures. As further monomer components, diunsaturated or polyunsaturated monomers are additionally frequently used as crosslinking agents in amounts of from 10 to 5000 ppm, based on the total monomer mixture. Suitable bifunctional crosslinking agents are, for example, methylene-bis-acrylamide and the acrylic acid esters and methacrylic acid esters of di- or polyhydric alcohols, such as ethylene glycol diacrylate and ethylene glycol dimethacrylate. Alkali metal bases, such as sodium hydroxide solution or potassium hydroxide solution, or ammonia are used for neutralizing the acid groups. The polymers isolated or the self-inverting water-in-oil emulsions can be used as thickeners in print pastes.

The disadvantage of these water-in-oil polymerizations is the emulsion polymerization procedure which in principle is not trivial and, in the case of the water-in-oil polymerization, the use of relatively large amounts of organic solvents. Furthermore, the isolation of the polymers also entails a considerable effort. Because particle sizes are frequently very small, the polymer cannot in fact be separated from the water-in-oil emulsions by filtration or centrifuging. In order to obtain them in pure form, it is instead necessray to flocculate the polymers from the emulsion and then to filter them. However, this working-up is not suitable for industrial use since, owing to the use of relatively large amounts of flocculants, complicated purification of the oil phase is required. Another method of working up such water-in-oil emulsions consists in subjecting the emulsion to azeotropic dewatering. WO-A-92/13912 describes such an azeotropic dewatering process, for example for obtaining agglomerated polymer particles from finely divided polymers containing ammonium carboxylate groups. This azeotropic dewatering is carried out in the presence of specific polyalkylene glycols having an agglomerating effect. Nevertheless, process engineering difficulties occur during the dewatering process, owing to nonreproducible hydrolysis of the polymer. According to DE-A-44 35 425, these difficulties can be overcome only by using in the azeotropic dewatering, in addition to the polyalkylene glycols, further specific polymers acting as protective colloids. After the removal of the water by azeotropic distillation, the agglomerated polymer particles are then present in a hydrocarbon oil, from which they have to be isolated by filtration, decanting of the hydrocarbon oil or centrifuging. Final adhering hydrocarbon oil is finally removed from the polymer particles by drying. A readily transportable and storable polymer which can be used as a thickener in print pastes is present only after this large number of working-up steps.

EP-A-0 670 335, EP-A-0 697 416 and EP-A-0 842 953 describe water-insoluble, pulverulent polymers which can be obtained by alkaline hydrolysis of aqueous, finely divided emulsions of uncrosslinked and/or crosslinked homo- and/or copolymers of acrylonitrile. These water-insoluble polymers are used as superabsorbers. For the preparation of the homo- and copolymers of acrylonitrile, exclusively the system rongalite (Na salt of hydroxymethanesulphinic acid)/H₂O₂ is explicitly described as an initiator. According to EP-A-0 842 953, the hydrolysis reaction can also be carried out in water/alcohol mixtures. What is decisive for the use as superabsorber is that the polymers obtained after the working-up are water-insoluble and have excellent swelling behaviour. It is emphasised that the method used for the polymerization of the acrylonitrile is important for this water insolubility of the polymers.

The object of the present invention was to provide a process by means of which novel polymers which are suitable as thickeners can be prepared and isolated in a manner which is technically simpler than by the known water-in-oil or oil-in-water polymerizations.

The invention relates to a process for the preparation of water-soluble homo- and/or copolymers containing alkali metal and/or alkaline earth metal carboxylate groups and based on acrylic or methacrylic derivatives, which is characterized in that

a) acrylonitrile and/or methacrylonitrile is polymerized using persulphate/SO₂ as a redox initiator in an aqueous medium and

b) the resulting aqueous emulsion of the homo- and/or copolymers of acrylonitrile and/or of methacrylonitrile is hydrolysed with alkali metal and/or alkaline earth metal hydroxides,

and the water-soluble homo- and/or copolymers obtained after step b) have

| | |
|---|---|
| 20-70 mol % | of alkali metal and/or alkaline earth metal carboxylate |
| | groups, |
| 20-70 mol % | of carboxamido groups and |
| 0-20 mol % | of residual nitrile groups, |

the mol % data being based on the sum of all nitrile groups which are contained in the homo- and copolymers of acrylonitrile or of methacrylonitrile before the hydrolysis according to step b).

In step a) of the process according to the invention, acrylonitrile and/or methacrylonitrile are used as monomers for the polymerization. In addition, one or more other comonomers can also be used. For example,

monoethylenic aromatic compounds, preferably styrene, α-methylstyrene or methoxystyrene,

monoethylenic aliphatic compounds, preferably vinyl acetate, acrylates, particularly preferably methyl acrylate, ethyl acrylate, n-butyl acrylate, isobutyl acrylate or tert-butyl acrylate, methacrylates, particularly preferably methyl methacrylate, ethyl methacrylate or n-butyl methacrylate, and

monoethylenic halogen-containing compounds, preferably vinyl chloride, vinylidene chloride or vinyl bromide,

are suitable.

These comonomers can be used individually or as a mixture, in addition to the acrylonitrile and/or methacrylonitrile.

The use of acrylonitrile or methacrylonitrile alone or of mixtures of acrylonitrile or of methacrylonitrile with n-butyl acrylate, tert-butyl acrylate, methyl methacrylate or vinyl acetate is preferred.

The proportion of the comonomers in the total amount of the comonomer mixture is preferably 0.5-20% by weight, particularly preferably 0.5-10% by weight.

If one or more of the abovementioned comonomers is used in addition to acrylonitrile and/or methacrylonitrile for the polymerization, the abovementioned mol % data with the functional groups of the copolymer obtained (alkali metal and/or alkaline earth metal carboxylate groups, carboxamido groups and residual nitrile groups) are based not on the totality of all nitrile groups before the hydrolysis according to step b) but on the totality of all hydrolysable functional groups in the copolymer before carrying out step b). This applies to all copolymers mentioned in this application.

In a specific embodiment of the process according to the invention, polyfunctional monomers, such as, for example, divinylbenzene, triallylamine, methylene glycol dimethacrylate or diethylene glycol divinyl ether, are additionally used in the polymerization of the acrylonitrile and/or methacrylonitrile and optionally of the abovementioned comonomers. In this case, correspondingly crosslinked homo- or copolymers are obtained. The polyfunctional monomers are used in amounts of 0.05-1.0% by weight, preferably 0.05-0.5% by weight, based on the total monomer mixture. Larger amounts of polyfunctional monomers cannot be used since otherwise the polymers resulting after the hydrolysis in step b) are no longer water-soluble.

The polymerization according to step a) of the process according to the invention can be carried out in the presence of specific anionic polymeric emulsifiers which are described in EP-A-0 590 460, to which reference is hereby expressly made. The anionic polymeric emulsifiers comprise a polymer containing structural units of the general formula (I) and/or (II)

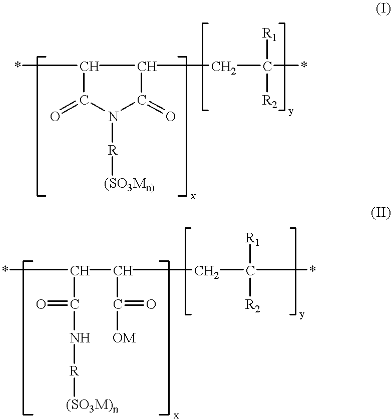

in which

M designates a cation-forming radical, preferably H, Na, K, NH₄ or R₃NH₃,

n designates 1 or 2,

R designates a hydrocarbon chain having 1-10 carbon atoms or an aromatic radical having 6-10 carbon atoms, preferably a radical derived from a C₁-C₄-alkane or from benzene, methylbenzene or naphthalene, or —(CH₂)₂NH(CH₂)₂—,

R₁ designates H or —CH₃,

R₂ designates H, C₁-C₁₆-alkyl, preferably —CH₃, —C₂H₅, —C₄H₉, —CH₂—C(CH₃)₃, —C₁₄H₂₉, —C₁₆H₃₃ or pheny,

R₃ designates a hydrocarbon radical of an amine and

x, y are chosen so that the weight average molecular weight M_{w} of the polymers (I) and (II) is from 2000 to 500,000, preferably from 5000 to 100,000 and the ratio x:y is from 1:4 to 1:1, preferably 1:3 to 1:1.

The polymerizations are preferably carried out by the feed process, in which the monomer or the monomer mixtures, the aqueous polymeric emulsifier and the two aqueous solutions of the persulphate and of SO₂ are metered in separately from one another. The proportion of the polymeric emlusifier is 2-4% by weight, preferably 2.2-3.6% by weight and particularly preferably 2.4-3.5% by weight, based on the amount of monomer used and the amount of polymeric emulsifier. Persulphates which may be used are all known salts, in particular ammonium, potassium and sodium persulphate. Sodium persulphate is preferred. The amount of persulphate used, based on the total amount of monomers, is 0.03-0.4% by weight, preferably 0.04-0.2% by weight, particularly preferably 0.04-0.1% by weight. The amount of SO₂ used, basd on the amount of monomers, is 0.01-0.15% by weight, preferably 0.02-0.1% by weight and particuarly preferably 0.02-0.05% by weight. The SO₂ may be metered in both separately as an aqueous solution, as described above, and in the monomer or monomer mixture. Separate metering as an aqueous solution is preferred. All doses can be kept constant or can be increased in the course of the polymerization. The polymerization temperature is in the range of 40-60° C., preferably of 48-52° C.

The aqueous emulsions obtained after step a) of the process according to the invention contain linear, uncrosslinked homo- and/or copolymers of acrylonitrile and/or of methacrylonitrile having molecular weights of from 5·10⁵ to 1·10⁷ g/mol, or crosslinked homo- and/or copolymers of acrylonitrile or of methacrylonitrile if the polymerization was carried out in the presence of polyfunctional comonomers.

The solids content of these aqueous high molecular weight emulsions is up to 55% by weight, preferably 10-55% by weight and particularly preferably 40-55% by weight.

The emulsions are very finely divided. The mean diameters of the polymer particles, determined by means of laser correlation spectroscopy, are in the range of 100-300 nm.

The polymer dispersions obtained after step a) need not be isolated or worked up but can be subjected directly to the hydrolysis in step b).

Alkali metal and/or alkaline earth metal hydroxides are used for hydrolysis. In particular, LiOH, NaOH, KOH and Ca(OH)₂ have proved useful. Here, it is possible directly to use solid, technical-grade alkali metal and/or alkaline earth metal hydroxide. However, it is also possible to use aqueous, 0.5-45% strength by weight or saturated solutions of the alkali metal and/or alkaline earth metal hydroxides. The molar ratio of the nitrile groups of the starting emulsion to the hydroxyl groups of the alkali metal and/or alkaline earth metal hydroxides is 1:(0.1-1), preferably 1:(0.35-1) and particularly preferably 1:(0.5-1).

The hydrolysis temperature is 50-100° C. and preferably 60-95° C. It is particularly preferable to implement a stepwise temperature programme, in which hydrolysis is effected initially at 60° C., then at 70° C. and finally, if required, at 85° C. Thereafter, it has proved useful to continue stirring for a certain period at 20° C.

In addition to the water, one or more C₁-C₄-alcohols and/or one or more polyglycols may also be present during the hydrolysis. Hydrolysis both in water/alcohol mixtures and in water/alcohol/polyglycol mixtures has proved useful.

Suitable C₁-C₄-alcohols are aliphatic monoalcohols, such as, for example, methanol, ethanol, n-propanol, isopropanol, n-butanol, isobutanol or tert-butanol. Ethanol, n-propanol, isopropanol and/or n-butanol are preferred. Compounds of the general formula (III)

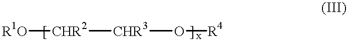

in which R¹ and R⁴ are identical or different and represent C₁-C₄-alkyl or hydrogen, R²and R³ are identical or different and denote hydrogen or methyl and x is an integer from 1-180, preferably from 1-70, particularly preferably from 5-25, can be used as polyglycols. Ethylene, diethylene, triethylene and tetraethylene glycols and very generally polyglycols having molar masses of 200-8000, preferably of 200-3000 and paticularly preferably of 200-1000 are preferably used.

The amount of water which is used for hydrolysing the polymer emulsions depends on the solids content of the polymer emulsion, on the amount of alcohols or of polyglycols and on the amount and the content of alkali metal hydroxide solution. Usually, both an increase in the water content of the hydrolysis mixture and an increase in the reaction temperature lead to an increase in the reaction rate. The water contents of the hydrolysis mixtures are usually 5-90% by weight, preferably 7.5-50% by weight and particularly preferably 10-30% by weight.

As a result of the hydrolysis carried out according to the invention, the emulsions present in finely divided form after step a) are transformed into readily stirrable and easily filterable and washable suspensions. Suspensions which are particularly easy to handle are obtained if the hydrolysis is carried out in a water/alcohol/polyglycol mixture. Usually, the powders are isolated by filtration, washed with alcohol, filtered again and dried.

The invention also relates to the water-soluble homo- and/or copolymers containing alkali metal and/or alkaline earth metal carboxylate groups and based on acrylic or methacrylic derivatives, which are obtainable by

a) polymerizing acrylonitrile and/or methacrylonitrile using persulphate/SO₂ as a redox initiator in an aqueous medium and

b) hydrolysing the resulting aqueous emulsion of the homo- and/or copolymers of acrylonitrile and/or of methacrylonitrile with alkali metal and/or alkaline earth metal hydroxides,

the water-soluble homo- and/or copolymers obtained after step b) having

| | |
|---|---|
| 20-70 mol % | of alkali metal and/or alkaline earth metal carboxylate |
| | groups, |
| 20-70 mol % | of carboxamido groups and |
| 0-20 mol % | of residual nitrile groups, |

the mol % data being based on the sum of all nitrile groups which are contained in the homo- and copolymers of acrylonitrile and/or of methacrylonitrile before the hydrolysis according to step b).

Preferably, the water-soluble homo- and/or copolymers according to the invention, containing alkali metal and/or alkaline earth metal carboxylate groups and based on acrylic or methacrylic derivatives contain

| | |
|---|---|
| 40-60 mol % | of alkali metal and/or alkaline earth metal carboxylate |
| | groups, |
| 40-60 mol % | of carboxamido groups and |

0-10 mol %, in particular 0.5-2 mol %, of residual nitrile groups.

In the case of all abovementioned homo- and/or copolymers containing alkali metal and/or alkaline earth metal carboxylate groups and based on acrylic or methacrylic derivatives, the sum of the mol % of the functional groups is preferably 100. In addition to said functional groups, small amounts of carboxyl groups and minimum amounts, below the limit of detection, of cyclic carboximido structures may also be present.

Surprisingly, it has been found that these homo- or copolymers according to the invention are water-soluble and have an excellent thickening effect in aqueous solutions.

What is decisive regarding the water solubility and the thickening effect of the homo- and/or copolymers according to the invention and containing alkali metal and/or alkaline earth metal carboxylate groups is the use of the specific redox initiator persulphate/SO₂ in combination with the hydrolysis step. Analogously prepared homo- or copolymers, in which however another initiator system, such as, for example, rongalite/H₂O₂, is used for the polymerization, give only water-insoluble, highly swellable polymers after hydrolysis.

The present invention thus also relates to the use of the water-soluble homo- or copolymers according to the invention, containing alkali metal and/or alkaline earth metal carboxylate groups and based on acrylic or methacrylic derivatives as thickeners for increasing the viscosity of aqueous systems. Preferably, the water-soluble homo- or copolymers according to the invention and containing alkali metal and/or alkaline earth metal carboxylate groups are used as thickeners for print pastes, and preferably for print pastes for printing textiles.

The invention furthermore relates to a process for the preparation of water-soluble homo- and/or copolymers containing carboxyl groups and based on acrylic or methacrylic derivatives, which is characterized in that

a) acrylonitrile and/or methacrylonitrile is polymerized using persulphate/SO₂ as a redox initiator in an aqueous medium,

b) the resulting aqueous emulsion of the homo- and/or copolymers of acrylonitrile and/or of methacrylonitrile is hydrolysed with alkali metal and/or alkaline earth metal hydroxides and

c) the resulting water-soluble homo- and/or copolymers containing alkali metal and/or alkaline earth metal carboxylate groups and based on acrylic or methacrylic derivates are reacted with acids,

the water-soluble homo- and/or copolymers obtained after step c) having

| | |
|---|---|
| 20-70 mol % | of carboxyl groups, |
| 20-70 mol % | of carboxamido groups and |
| 0-20 mol % | of residual nitrile groups, |

the mol % data being based on the sum of all nitrile groups which are contained in the homo- and copolymers of acrylonitrile and/or of methacrylonitrile before the hydrolysis according to step b) and

the carboxyl groups having an alkali metal and/or alkaline earth metal content of <5 mol %, based on the total number of all carboxyl groups.

The reaction with the acid is usually effected in the course of a washing step.

Organic acids have proved useful acids.

C₁-C₃-Monocarboxlic acids, in particular formic acid, acetic acid, propionic acid or lactic acid

C₂-C₆-di- and polycarboxylic acids, in particular oxalic acid, malonic acid, succinic acid, citric acid or adipic acid are preferred.

Other preferred acids are inorganic mineral acids, in particular hydrochloric acid, sulphuric acid or phosphoric acid.

Mixtures of the abovementioned acids may also be used. At the same time, it is also possible to use the aliphatic C₁-C₄-alcohols and/or glycols already described above, in addition to the acids. For example, methanol, ethanol, n-propanol, isopropanol, n-butanol, isobutanol, tert-butanol and/or ethylene glycol are suitable.

The treatment of the water-soluble homo- or copolymers according to the invention and obtained after step b) with the acid can be carried out continuously or batchwise. Both the continuous and the batchwise procedure can be effected in suitable dialysis or membrane apparatuses. For the batchwise procedure, furthermore, all standard reaction containers suitable for this purpose can be used. The products obtained after the acidification can easily be filtered and dried.

The invention thus furthermore relates to the water-soluble homo- and/or copolymers containing carboxyl groups and based on acrylic or methacrylic derivatives, which are obtainable by

a) polymerizing acrylonitrile and/or methacrylonitrile using persulphate/SO₂ as a redox initiator in an aqueous medium,

b) hydrolysing the resulting aqueous emulsion of the homo- and/or copolymers of acrylonitrile and/or of methacrylonitrile with alkali metal and/or alkaline earth metal hydroxides and

c) reacting the resulting water-soluble homo- and/or copolymers containing alkali metal and/or alkaline earth metal groups and based on acrylic or methacrylic derivatives with acids,

the water-soluble homo- and/or copolymers obtained after step c) having

| | |
|---|---|
| 20-70 mol % | of carboxyl groups, |
| 20-70 mol % | of carboxamido groups and |
| 0-20 mol % | of residual nitrile groups, |

and

the mol % data being based on the sum of all nitrile groups which are contained in the homo- and copolymers of acrylonitrile and/or of methacrylonitrile before the hydrolysis according to step b) and

the carboxyl groups having an alkali metal and/or alkaline earth metal content of <5 mol %, based on the total number of all carboxyl groups.

Preferably, the water-soluble homo- or copolymers present after this acidification, containing carboxyl groups and based on acrylic or methacrylic derivatives have

| | |
|---|---|
| 40-60 mol % | of carboxyl groups, |
| 40-60 mol % | of carboxamido groups and |

0-10, in particular 0.5-2, mol % of residual nitrile groups,

the mol % data being based on the sum of all nitrile groups which are contained in the homo- and copolymers of acrylonitrile and/or of methacrylonitrile before the hydrolysis according to step b) and

the carboxyl groups having only an alkali metal and/or alkaline earth metal content of <5 mol %, based on the total number of all carboxyl groups.

Particularly preferably, the homo- and/or copolymers containing carboxyl groups and based on acrylic or methacrylic derivatives have only an alkali metal and/or alkaline earth metal content of <3 mol % and in particular of <1.5 mol %, based on the total number of all carboxyl groups.

In the case of these abovementioned water-soluble homo- and/or copolymers containing carboxyl groups and based on acrylic or methacrylic derivatives, the sum of the mol % of said functional groups is preferably 100.

Surprisingly, these water-soluble homo- and/or copolymers containing carboxyl groups also have an excellent thickening effect in aqueous systems.

The invention therefore also relates to the use of the homo- and/or copolymers containing carboxyl groups and based on acrylic or methacrylic derivatives for increasing the viscosity of aqueous systems, preferably for increasing the viscosity of print pastes, particularly preferably of print pastes for printing textiles, and in particular for increasing the viscosity of print pastes which contain at least one pigment for colouring textiles.

The invention furthermore relates to print pastes containing

a) either

a1) the water-soluble homo- and/or copolymers according to the invention, containing alkali metal and/or alkaline earth metal carboxylate groups and based on acrylic or methacrylic derivatives or

a2) the corresponding water-soluble homo- and/or copolymers according to the invention, containing carboxyl groups and based on acrylic or methacrylic derivatives

and

b) one or more binders,

c) one or more dyes or pigments and

d) ammonia.

Print pastes which contain, as component a) a1), the water-soluble homo- or copolymers containing alkali metal and/or alkaline earth metal carboxylate groups and based on acrylic or methacrylic derivatives and, as component c), one or more reactive dyes and/or one or more disperse dyes are preferred.

Furthermore, print pastes which contain, as component a) a2), the water-soluble homo- or copolymers containing carboxyl groups and based on acrylic or methacrylic derivatives and, as component c), one or more pigments are preferred.

In addition to the components a)-d), the print pastes may also contain conventional additives customary for print pastes. These additives are selected from the group consisting of the antifoams, emulsifiers, plasticizers, crosslinking agents, acid additives, accelerators, ammonia and amine bases.

The fixing agents required for the respective dye class and also hydrotropic agents, such as urea, glycols and glycol ethers, may also be present in the print pastes. Further suitable bases are sodium carbonate, potassium carbonate, sodium bicarbonate, sodium hydroxide solution, potassium hydroxide solution or alkali donors, such as, for example, sodium trichloroacetate. Further auxiliaries are, for example, tartaric acid, citric acid or lactic acid or acid donors, such as diammonium phosphate. In addition, the print pastes may contain as emulsifiers, for example, nonionic reaction products of alkylene oxides with phenols or fatty alcohols and anionic compounds.

Preferred pigment print pastes are generally composed of

| | | |
|---|---|---|
| 0.75-2% | by weight | of thickener according to the |
| | | invention |
| 5-25% | by weight | of binder |
| 0.01-6% | by weight | of pigment pastes |
| 0-1, preferably 0.5, % | by weight | of emulsifiers/flow improvers |
| 0-2% | by weight | of plasticizers |
| 0-2% | by weight | of crosslinking agents |
| 0.1-3% | by weight | of 25% strength ammonia water and |
| 59-94.14% | by weight | of water, |

the sum of the % by weight of said components being 100. For the preparation of such pigment pastes, the auxiliaries, the pigments and the thickener are mixed using high-speed stirrers.

Suitable binders are acrylate-based, butadiene/acrylonitrile-based and polyurethane-based dispersion binders. Suitable emulsifiers or flow improvers are in particular conventional, nonionic emulsifiers. In particular, silicone oil-containing O/W dispersions or pure silicone oils may be used as plasticizers. In particular, melamine resins are used as crosslinking agents. Pigment pastes are commercially available. The print pastes for printing with reactive dyes or disperse dyes furthermore have a customary composition, as described, for example, in DE-A-195 06 287.

It is to be assumed that, in the print pastes according to the invention, the component a) reacts with the ammonia d) to give the corresponding ammonium salts of component a).

In a particular variant, it is therefore also possible initially to react the water-soluble homo- and/or copolymers according to the invention, containing alkali metal and/or alkaline earth metal carboxylate groups and based on acrylic or methacrylic derivatives or the corresponding water-soluble homo- and/or copolymers according to the invention, containing carboxyl groups and based on acrylic or methacrylic derivatives separately with ammonia to give the corresponding ammonium salts.

The invention thus also relates to a process for the preparation of homo- and/or copolymers containing ammonium carboxylate groups and based on acrylic or methacrylic derivatives, which have

| | |
|---|---|
| 20-70 mol % | of ammonium carboxylate groups, |
| 20-70 mol % | of carboxamido groups and |
| 0-20 mol % | of residual nitrile groups, |

by reacting the water-soluble homo- and/or copolymers obtainable after steps a) and b), containing alkali metal and/or alkaline earth metal carboxylate groups and based on acrylic or methacrylic derivatives, which have

| | |
|---|---|
| 20-70 mol % | of alkali metal and/or alkaline earth metal carboxylate |
| | groups, |
| 20-70 mol % | of carboxamido groups and |
| 0-20 mol % | of residual nitrile groups, |

or the water-soluble homo- and/or copolymers obtainable via the steps a), b) and c), containing carboxyl groups and based on acrylic or methacrylic derivatives, which have

| | |
|---|---|
| 20-70 mol % | of carboxyl groups, |
| 20-70 mol % | of carboxamido groups and |
| 0-20 mol % | of residual nitrile groups, |
| | with ammonia. |

The invention furthermore relates to the water-soluble homo- and/or copolymers obtainable by this process, containing ammonium carboxylate groups and based on acrylic or methacrylic derivatives, which have

| | |
|---|---|
| 20-70 mol %, | preferably 40-60 mol %, of ammonium carboxylate |
| | groups. |
| 20-70 mol %, | preferably 40-60 mol %, of carboxamido groups and |
| 0-20 mol %, | preferably 0-10 mol % and in particular 0.5-2 mol %, |
| | of residual nitrile groups. |

In the case of these abovementioned water-soluble homo- and/or copolymers containing ammonium carboxylate groups and based on acrylic or methacrylic derivatives, the sum of the mol % of the functional groups is preferably 100. Very small amounts of alkali metal and/or alkaline earth metal carboxylate groups and/or carboxyl groups may also be present.

The invention also relates to the use of these water-soluble homo- and/or copolymers containing ammonium carboxylate groups and based on acrylic or methacrylic derivatives for increasing the viscosity of aqueous systems, preferably for increasing the viscosity of print pastes for printing textiles.

The invention furthermore relates to the print pastes containing

a3) the water-soluble homo- and/or copolymers according to the invention, containing ammonium carboxylate groups and based on acrylic or methacrylic derivatives

and

b) one or more binders and

c) one or more dyes or pigments.

The print pastes are prepared by simple mixing of the components.

All additives otherwise possible correspond to the additives already stated for the other print pastes according to the invention.

The invention furthermore relates to a process for the treatment of textiles with all abovementioned print pastes. The treatment of the textiles with the print pastes is usually carried out by printing the print pastes onto the fabric, preferably using a doctor blade.

All known textiles, such as, cotton, polyester, viscose, polyamide, polyacrylate, polypropylene, wool, silk, linen, rayon, acetate, triacetate, hemp, jute, carbon fibres and glass fibres and mixtures of these materials may be used as textiles to be treated. Here, any form of the textiles may be used. For example, woven fabrics, knitted fabrics or ribbons are suitable.

The invention furthermore relates to the textiles treated with the abovementioned print pastes.

The various water-soluble polymers according to the invention have an excellent, highly thickening effect in aqueous systems. The print pastes containing the polymers according to the invention permit a good colour yield in the treatment of the textiles and lead to a good surface print. The textiles thus treated moreover have excellent dry and wet fastness.

### EXAMPLES

A Preparation of a Polymeric Emulsifier Containing Sulphonic Acid Groups

The following were initially introduced into a 6 l V4A stainless steel autoclave while passing over nitrogen:

| | |
|---|---|
| 2342 g | of demineralized water |
| 546 g | of an alternating maleic anhydride/diisobutylene copolymer |
| 1506 g | of Na taurinate solution in water (solids content: |
| | 25.0% by weight) |

After the autoclave is closed, the internal temperature is brought to 100° C. and stirring is carried out for 10 hours at this temperature and for a further 10 hours at 140° C.

Cooling is then effected to room temperature and the reactor content is filtered over a filter cloth. The clear filtrate has a solids content of 19.6% by weight and contains a polymer having more than 90% of the repeating units corresponding to the following formula (I). The remainder corresponds to units of the formula (II) (determined by IR spectroscopy).

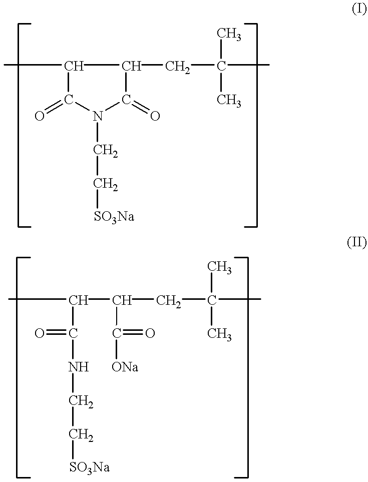

B Preparation of a Polyacrylonitrile Emulsion

| | |
|---|---|
| 602.1 g | of demineralized water, |
| 2.2 g | of 1 N H₂SO₄ and |
| 65.1 g | of the 19.6% strength by weight, aqueous solution of the |
| | polymeric emulsifier containing sulphonic acid groups, which |
| | solution is prepared according to A, |

are initially introduced into a 4 l four-necked flask and heated to 50° C. while stirring.

1.10 g of an aqueous 0.1% strength iron(II) sulphate solution are then added. The solutions 1 to 4 are then metered separately into this reaction mixture at 50-54° C. and a stirring speed of 150 rpm in the course of 6 hours.

| | |
|---|---|
| Solution 1: | 1000 g of acrylonitrile |
| Solution 2: | 132.0 g of demineralized water |
| | 0.660 g of NaS₂O₈ |
| Solution 3: | 121.8 g of demineralized water |
| | 10.48 g of demineralized water: SO₂ = (97.5:2.5) % by |
| | weight |
| Solution 4: | 165.0 g of demineralized water |
| | 112.3 g of the 19.6% strength by weight aqueous solution |
| | of the polymeric emulsifier containing sulphonic acid |
| | groups, which solution is prepared according to A |

After addition is complete, stirring is continued for a further 2 hours. The residual monomers are removed by distilling off water until a solids content of about 51.0% by weight is reached. After filtration of the dispersion through a 100 μm filter cloth, a residue of 4.13 g remains.

Characterization of the Dispersion:

| | |
|---|---|
| Solids, content: | 51.0% |
| [η]: | 6.5 dl/g |
| M_{w}: | 1.9 · 10⁶ g/mol |

C Hydrolysis of the Polyacrylonitrile

### Example C1

In a stir-red flask, 323.0 g of n-propanol, 165.0 g of diethylene glycol, 265.5 g of polyethylene glycol having a molar mass of 400 and 366.8 g of the polyacrylonitrile emulsion prepared according to B and having a solids content of 51.8% by weight are mixed. Furthermore, 117.0 g of solid sodium hydroxide are dissolved while stir-ring. Thus, 0.845 mol of hydroxide is used per mole of nitrile group. The water content of the hydrolysis mixture is 14.3% by weight. The mixture is then subjected to the following temperature programme while stirring: 1 h at 60° C., 2 h at 70° C., 20 h at 20° C.

After cooling to room temperature, filtration is carried out, washing is effected with propanol and drying and milling are carried out. The water-soluble polymers thus obtained have, in addition to amide structures, in particular carboxylate structures and only a few nitrile structures (structure determination by infrared spectroscopy).

### Example C2

In a stirred flask, 270.0 g of n-propanol, 360.0 g of tetraethylene glycol and 342.0 g of the polyacrylonitrile emulsion prepared according to B and having a solids content of 45.6% by weight are mixed. Furthermore, 69.6 g of solid sodium hydroxide are dissolved while stirring. Thus, 0.613 mol of hydroxide is used per mole of nitrile group. The water content of the hydrolysis mixture is 17.9% by weight. The mixture is then subjected to the following temperature programme while stirring: 1 h at 60° C., 2 h at 70° C., 20 h at 20° C.

After cooling to room temperature, filtration is carried out, rinsing is effected with propanol and drying and milling are carried out. The water-soluble polymers thus obtained have, in addition to amide structures, in particular carboxylate structures and only a few nitrile structures (structure determination by infrared spectroscopy).

### Example C3

In a stirred flask, 270.0 g of n-propanol, 360.0 g of tetraethylene glycol and 315.0 g of the polyacrylonitrile emulsion prepared according to B and having a solids content of 49.4% by weight are mixed. Furthermore, 115.0 g of solid sodium hydroxide are dissolved while stirring. Thus, 1.0 mol of hydroxide is used per mole of nitrile group. The water content of the hydrolysis mixture is 15.0% by weight. The mixture is then subjected to the following temperature programme while stirring: 1 h at 60° C., 2 h at 70° C., 20 h at 20° C.

After cooling to room temperature, filtration is carried out, rinsing is effected with propanol and drying and milling are carried out. The water-soluble polymers thus obtained have, in addition to amide structures, in particular carboxylate structures and only a few nitrile structures (structure determination by infrared spectroscopy).

Table 1 shows the viscosities of the polymers prepared in Examples C1, C2 and C3, at various concentrations in demineralized water. For comparison therewith, Table 1 also shows the viscosities of two commercial thickeners (C V1 and C V2) for textile printing, at various concentrations, likewise in demineralized water. The two commercial thickeners for textile printing are products which are based on ammonium polyacrylate and prepared by water-in-oil polymerization. The thickener C V1 for textile printing is an emulsion containing 25% by weight of a copolymer of ammonium acrylate and acrylamide (Acraconz®BN from Bayer AG, Germany), and the thickener C V2 for textile printing is a pulverulent product (Lutexal®P from BASF AG, Germany) (also see DE-A-44 35 425).

TABLE 1
Viscosities of the water-soluble polymers in demineralized water
at various concentrations

| Concentration | | | | |
|---|---|---|---|---|
| [% by weight] | 0.125 | 0.25 | 0.50 | 1.00 |

| | |
|---|---|
| Example | Viscosities[Pas] |

| | | | | |
|---|---|---|---|---|
| C1 | 1.46 | 3.4 | 5.63 | 7.68 |
| C2 | 0.176 | 4.04 | 6.98 | 11.9 |
| C3 | 0.586 | 0.938 | 1.64 | 3.05 |
| C V1 | 0.469 | 1.7 | 3.52 | 5.63 |
| C V2 | 0.176 | 1.76 | 5.63 | 10.7 |

It is found that, with the polymers obtained according to the invention, a broad viscosity range can be covered by varying the hydrolysis conditions (base content/solvent) and it is therefore possible to prepare thickeners which in some cases are substantially superior to the commercial standard systems in their viscosity effect.

D Carrying out the Acidification

85.6 g of the polymer prepared in Example C1 are suspended in 1000 g of a 50:50 solvent mixture comprising 85% strength formic acid and propanol, transferred to a dialysis tube and left therein for 24 hours. Thereafter, the product is filtered off, washed once with propanol and dried at 50° C.

The water-soluble polymer D1 thus obtained has, in addition to amide structures, in particular free carboxylic acid structures and only a few nitrile structures (structure determination by infrared spectroscopy).

E Preparation of the Ammonium Salts of the Polymers

A 0.5% strength aqueous solution which contains 3 g of 25% strength ammonia per kg is prepared from the product obtained in Example D (Example E1).

Table 2 shows some properties of the solution thus obtained, in comparison with a solution which is prepared using the commercial thickener CVI based on acrylic acid (2.75% strength by weight aqueous solution of a 25% strength emulsion):

TABLE 2
Comparison of the product properties in aqueous solution

| | Thickener | Swelling | | |
|---|---|---|---|---|
| | [g/kg of | time | | Viscosity^{a} |
| Example | solution] | [s] | pH | [mPas] |
| E1 | 5 | 10 | 8.7 | 12,060 |
| CV1 | 6.875 | 10 | 8.7 | 10,000 |

^{a)}Measured in the presence of 3 g/kg of diammonium phosphate solution using Rotovisko RV 12, rotating body MV III, D = 1.76s⁻¹

It is clearly evident that, even with the use of smaller amounts of the thickener according to the invention in Example E1 in comparison with the commercial thickener CV1, equally good results are achieved with respect to the swelling time and the pH and even improvements are observed with respect to the viscosity of the thickened solution.

F Preparation of the Print Pastes

### Example F1

(According to the Invention)

A print paste consisting of 818.5 g of water, 100 g of commercial acrylate dispersion binder (Acramin®ALW from Bayer AG, Germany), 3 g of 25% strength ammonia water, 3 g of an antifoam silicon oil dispersion (RespumitφSD from Bayer AG, Germany), 40 g of a textile printing auxiliary consisting of etherified melamine resin and silicone or mineral oils and emulsifiers (Acrafix®UC 03 from Bayer AG, Germany), 30 g of a blue pigment colour (Acramin® Navy Blue FBC₁₅₀% from Bayer AG, Germany) and 5.5 g of the polymer prepared in Example D1 is prepared, mixed using a high-speed stirrer and printed on a cotton fabric with the aid of a film printing screen. The printed textile is dried at 80° C. to constant weight and fixed for 5 min at 150° C. The application-relevant properties are summarized in Table 3.

### Example F2

(According to the Invention)

A print paste is prepared as in Example F1 but in this case is printed on a 50:50 polyester/cotton union fabric. The application-relevant properties are summarized in Table 3.

### Example FV1

(Comparative Print Paste)

A print paste consisting of 800.0 g of water, 100 g of the acrylate dispersion binder from Example F1, 3 g of the antifoam silicone oil dispersion from Example F1, 40 g of the textile printing auxiliary from Example F1, 30 g of the blue pigment colour from Example F1 and 27.0 g of the commercial thickener CVI for textile printing, based on polyacrylic acid (25% strength emulsion in oil), is prepared, mixed using a high-speed stirrer and printed on a cotton fabric with the aid of a film printing screen. The printed textile is dried at 80° C. to constant weight and fixed for 5 min at 150° C. The application-relevant properties are summarized in Table 3.

### Example FV2

(Comparative Print Paste)

A print paste is prepared as in Example FV1 but in this case is printed on a polyester/cotton union fabric (50% polyester content). The application-relevant properties are summarized in Table 3.

Table 3 clearly shows that the prints produced with the thickener systems prepared according to the invention will have properties with respect to printed copies which are at least equivalent to those of prints which were produced using the commercial thickener CV1. Particularly in the surface print and contour crispness (cotton/polyester union fabric), substantial advantages are detectable.

Performance Tests:

For checking the properties with respect to printed copies when the print pastes prepared above are used, the fastnesses (dry and wet) according to DIN 54021 and the contour crispness, the surface printing and the colour yield are assessed visually relative to one another. For washing in the brush washer, the printed textile is introduced into a soap bath consisting of 2.5 g of Marseilles soap (Na salt of fatty acid of olive or cotton seed oils), 1.0 g of sodium carbonate and 2.0 g of Trilon B (ethylene-N,N,N′,N′-tetraacetic acid, Na₄ salt) in 1 l of water for 10 min at 80° C. and then brushed 100 times in the case of a pure cotton fabric or 50 times in the case of a cotton/polyester union fabric with a Perlon brush which was placed in the soap solution for 15 min at 80° C. Here too, a visual comparison is made with the commercial systems.

TABLE 3
Comparison of the printed textiles

| Example | F1^{a} | F2^{b} | FV1 | FV2 |
|---|---|---|---|---|
| Active | 0.55 | 0.55 | 0.675 | 0.675 |
| ingredient | | | | |
| concentration | | | | |
| [% by weight] | | | | |
| Viscosity^{c} | 6500 | 6500 | 6500 | 6500 |
| [mPas] | | | | |
| Colour yield | s | s | | |
| Surface printing | su+ | su+ | | |
| Dry fastness | s | s | | |
| Washing in | | | | |
| brush washer | | | | |
| Wet fastness | s | s | | |
| Contour | s | so+ | | |
| crispness | | | | |

^{a)}Comparison of the properties of the printed copies with FV1 (cotton)
^{b)}Comparison of the properties of the printed copies with FV2 (cotton/polyester union fabric)
^{c)}Brookfield RVII, Sp 6/50 revs
s: similar; su: substantially; so: somewhat; +: better

1. Process for the preparation of water-soluble homo- and/or copolymers containing alkali metal and/or alkaline earth metal carboxylate groups and based on acrylic or methacrylic derivatives, which is characterized in that
a) acrylonitrile and/or methacrylonitrile is polymerized using persulphate/SO₂ as a redox initiator in an aqueous medium and
b) the resulting aqueous emulsion of the homo- and/or copolymers of acrylonitrile and/or of methacrylonitrile is hydrolysed with alkali metal and/or alkaline earth metal hydroxides,
and the water-soluble homo- and/or copolymers obtained after step b) have

| | |
|---|---|
| 20-70 mol % | of alkali metal and/or alkaline earth metal |
| | carboxylate groups, |
| 20-70 mol % | of carboxamido groups and |
| 0-20 mol % | of residual nitrile groups, |

the mol % data being based on the sum of all nitrile groups which are contained in the homo- and/or copolymers of acrylonitrile and/or of methacrylonitrile before the hydrolysis according to step b).

2. Process according to claim 1, characterized in that, in step a), one or more other comonomers, preferably monoethylenic aromatic compounds, particularly preferably styrene, α-methylstyrene or methoxystyrene, monoethylenic aliphatic compounds, particularly preferably vinyl acetate, acrylates, in particular methyl acrylate, ethyl acrylate, n-butyl acrylate, isobutyl acrylate or tert-butyl acrylate, methacrylates, in particular methyl methacrylate or ethyl methacrylate or n-butyl methacrylate, or monoethylenic halogen-containing compounds, preferably vinyl chloride, vinylidene chloride or vinyl bromide, are also used as monomers in addition to acrylonitrile and/or methacrylonitrile.

3. Process according to claim 2, characterized in that, in step a), acrylonitrile or methacrylonitrile alone or mixtures of acrylonitrile or of methacrylonitrile with n-butyl acrylate, tert-butyl acrylate, methyl methacrylate or vinyl acetate are used.

4. Process according to claim 2 or 3, characterized in that the proportion of the comonomers in the total amount of the comonomer mixture is 0.5-20% by weight, preferably 0.5-10% by weight.

5. Process according to one or more of claims 1-4, characterized in that, in step a), polyfunctional monomers, preferably divinylbenzene, triallylamine, ethylene glycol dimethacrylate or diethylene glycol divinyl ether, are additionally used, in amounts of 0.05-1.0% by weight, preferably 0.05-0.5% by weight, based on the total monomer mixture.

6. Process according to one or more of claims 1-5, characterized in that the aqueous emulsions obtained after step a) contain linear, uncrosslinked homo- and/or copolymers of acrylonitrile and/or of methacrylonitrile having molecular weights of from 5·10⁵ to 1·10⁷ g/mol and/or crosslinked homo- and/or copolymers of acrylonitrile or of methacrylonitrile, if the polymerization is carried out in the presence of polyfunctional comonomers according to claim 5.

7. Process according to one or more of claims 1-6, characterized in that the solids content of the aqueous, finely divided, high molecular weight emulsions obtained after step a) is up to 55% by weight, preferably 10-55% by weight and particularly preferably 40-55% by weight and the mean diameters of the polymer particles, determined by means of laser correlation spectroscopy, are in the range of 100-300 nm.

8. Process according to one or more of claims 1-7, characterized in that LiOH, NaOH, KOH or Ca(OH)₂ are used as alkali metal and/or alkaline earth metal hydroxide in step b), preferably in solid form or as aqueous, 0.5-45% strength by weight or saturated solutions.

9. Process according to one or more of claims 1-8, characterized in that the molar ratio of the nitrile groups of the emulsion after step a) to the hydroxyl groups of the alkali metal and/or alkaline earth metal hydroxides is 1:(0.1-1), preferably 1:(0.35-1) and particularly preferably 1:(0.5-1).

10. Process according to one or more of claims 1-9, characterized in that the hydrolysis temperature is 50-100° C. and preferably 60-95° C.

11. Process according to one or more of claims 1-10, characterized in that one or more C₁-C₄-alcohols and/or one or more polyglycols are additionally present in step b) in addition to the water.

12. Process according to claim 11, characterized in that the C₁-C₄-alcohols used are aliphatic monoalcohols, preferably methanol, ethanol, n-propanol, isopropanol, n-butanol, isobutanol or tert-butanol and/or the polyglycols used are compounds of the general formula (III) 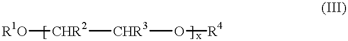
in which R¹ and R⁴ are identical or different and represent C₁-C₄-alkyl or hydrogen, R² and R³ are identical or different and denote hydrogen or methyl and x is an integer from 1-180, preferably from 1-70 and in particular from 5-25.

13. Process according to claim 12, characterized in that ethylene, diethylene, triethylene or tetraethylene glycols or polyglycols having molar masses of 200-8000, preferably of 200-3000 and particularly preferably of 200-1000 are used.

14. Process according to one or more of claims 1-13, characterized in that the water content of the hydrolysis mixtures is 5-90% by weight, preferably 7.5-50% by weight and particularly preferably 10-30% by weight.

15. Water-soluble homo- and/or copolymers containing alkali metal and/or alkaline earth metal carboxylate groups and based on acrylic or methacrylic derivatives, obtainable by the process according to one or more of claims 1-14.

16. Water-soluble homo- and/or copolymers containing alkali metal and/or alkaline earth metal carboxylate groups and based on acrylic or methacrylic derivatives, according to claim 15, characterized in that they contain

| | |
|---|---|
| 40-60 mol % | of alkali metal and/or alkaline earth metal carboxylate |
| | groups, |
| 40-60 mol % | of carboxamido groups and |
| 0-10 mol %, | preferably 0.5-2 mol %, of residual nitrile groups. |

17. Use of the water-soluble homo- and/or copolymers containing alkali metal and/or alkaline earth metal carboxylate groups and based on acrylic or methacrylic derivatives, according to claim 15 or 16, as thickeners for increasing the viscosity of aqueous systems.

18. Use of the water-soluble homo- and/or copolymers containing alkali metal and/or alkaline earth metal carboxylate groups and based on acrylic or methacrylic derivatives, according to claim 17, as thickeners for print pastes, preferably for print pastes for printing textiles.

19. Process for the preparation of water-soluble homo- and/or copolymers containing carboxyl groups and based on acrylic or methacrylic derivatives, which is characterized in that
a) acrylonitrile and/or methacrylonitrile is polymerized using persulphate/SO₂ as a redox initiator in an aqueous medium,
b) the resulting aqueous emulsion of the homo- and/or copolymers of acrylonitrile and/or of methacrylonitrile is hydrolysed with alkali metal and/or alkaline earth metal hydroxides and
c) the resulting water-soluble homo- and/or copolymers containing alkali metal and/or alkaline earth metal carboxylate groups and based on acrylic or methacrylic derivatives are reacted with acids,
the water-soluble homo- and/or copolymers obtained after step c) having

| | |
|---|---|
| 20-70 mol % | of carboxyl groups, |
| 20-70 mol % | of carboxamido groups and |
| 0-20 mol % | of residual nitrile groups |

the mol % data being based on the sum of all nitrile groups which are contained in the homo- and copolymers of acrylonitrile and/or of methacrylonitrile before the hydrolysis according to step b) and
the carboxyl groups having only an alkali metal and/or alkaline earth metal content of <5 mol %, based on the total number of all carboxyl groups.

20. Process according to claim 19, characterized in that, in step c), organic acids, preferably C₁-C₃-monocarboxylic acids, particularly preferably formic acid, acetic acid, propionic acid or lactic acid, C₂-C₆-di- or polycarboxylic acids, particularly preferably oxalic acid, malonic acid, succinic acid, citric acid or adipic acid, and inorganic mineral acids, preferably hydrochloric acid, sulphuric acid or phosphoric acid, or mixtures of these are used as acids.

21. Process according to claim 19 or 20, characterized in that C₁-C₄-alcohols and/or one or more polyglycols according to claim 12 or 13 are also used in addition to the acids.

22. Process according to one or more of claims 19-21, characterized in that step c) is carried out continuously or batchwise.

23. Water-soluble, homo- and/or copolymers containing carboxyl groups and based on acrylic or methacrylic derivatives, obtainable by the process according to one or more of claims 19-22.

24. Water-soluble, homo- and/or copolymers containing carboxyl groups and based on acrylic or methacrylic derivatives, obtainable by the process according to one or more of claims 19-22, characterized in that they contain

| | |
|---|---|
| 40-60 mol % | of carboxyl groups, |
| 40-60 mol % | of carboxamido groups and |
| 0-10 mol %, | preferably 0.5-2 mol %, of residual nitrile groups, |

the mol % data being based on the sum of all nitrile groups which are contained in the homo- and copolymers of acrylonitrile and/or of methacrylonitrile before the hydrolysis according to step b) and
the carboxyl groups have only an alkali metal and/or alkaline earth metal content of <5 mol %, based on the total number of all carboxyl groups.

25. Water-soluble homo- and/or copolymers containing carboxyl groups and based on acrylic or methacrylic derivatives, according to claim 24, characterized in that the carboxyl groups have only an alkali metal and/or alkaline earth metal content of <3 mol %, preferably of <1.5 mol %, based on the total number of all carboxyl groups.

26. Use of the water-soluble homo- and/or copolymers containing carboxyl groups and based on acrylic or methacrylic derivatives, according to one or more of claims 23-25, as thickeners for increasing the viscosity of aqueous systems.

27. Use of the water-soluble homo- and/or copolymers containing carboxyl groups and based on acrylic or methacrylic derivatives, according to claim 26, as thickeners for increasing the viscosity of print pastes for printing textiles, preferably of print pastes which contain at least one pigment for printing textiles.

28. Print pastes containing
a) either
a1) the water-soluble homo- and/or copolymers containing alkali metal and/or alkaline earth metal carboxylate groups and based on acrylic or methacrylic derivatives, according to claim 15 or 16, or
a2) the corresponding water-soluble homo- and/or copolymers containing carboxyl groups and based on acrylic or methacrylic derivatives, according to one or more of claims 23-25,
and
b) one or more binders,
c) one or more dyes or pigments and
d) ammonia.

29. Print pastes according to claim 28, characterized in that they contain, as component a) a1), the water-soluble homo- and/or copolymers containing alkali metal and/or alkaline earth metal carboxylate groups and based on acrylic or methacrylic derivatives, according to claim 15 or 16, and, as component c), one or more reactive dyes and/or one or more disperse dyes.

30. Print pastes according to claim 28, characterized in that they contain, as component a) a2), the water-soluble homo- and/or copolymers containing carboxyl groups and based on acrylic or methacrylic derivatives, according to one or more of claims 23-25, and, as component c), one or more pigments.

31. Print pastes according to one or more of claims 28-30, characterized in that they additionally have one or more additives selected from the group consisting of the antifoams, emulsifiers, plasticizers, crosslinking agents, acid additives, accelerators and amine bases.

32. Process for the preparation of homo- or copolymers containing ammonium carboxylate groups and based on acrylic or methacrylic derivatives, characterized in that the water-soluble homo- and/or copolymers obtainable according to one or more of claims 1-14, containing alkali metal and/or alkaline earth metal carboxylate groups and based on acrylic or methacrylic derivatives or the water-soluble homo- and/or copolymers obtainable according to claims 23-25, containing carboxyl groups and based on acrylic or methacrylic derivatives are reacted with ammonia, the resulting homo- and/or copolymers containing ammonium carboxylate groups and based on acrylic or methacrylic derivatives having

| | |
|---|---|
| 20-70 mol % | of ammonium carboxylate groups, |
| 20-70 mol % | of carboxamido groups and |
| 0-20 mol % | of residual nitrile groups. |

33. Water-soluble homo- and/or copolymers containing ammonium carboxylate groups and based on acrylic or methacrylic derivatives, which have

| | |
|---|---|
| 20-70 mol %, | preferably 40-60 mol %, of ammonium carboxylate |
| | groups, |
| 20-70 mol %, | preferably 40-60 mol %, of carboxamido groups and |
| 0-20 mol %, | preferably 0-10 mol %, in particular 0.5-2 mol %, of |
| | residual nitrile groups, |

and are obtainable by the process according to claim 32.

34. Use of the water-soluble homo- and/or copolymers containing ammonium carboxylate groups and based on acrylic or methacrylic derivatives, according to claim 33, for increasing the viscosity of aqueous systems, preferably for increasing the viscosity of print pastes for printing textiles.

35. Print pastes containing
a3) the water-soluble homo- or copolymers containing ammonium carboxylate groups and based on acrylic or methacrylic derivatives, according to claim 33, and
b) one or more binders and
c) one or more dyes or pigments.

36. Process for printing textiles, characterized in that the textiles, preferably cotton textiles or polyester/cotton union textiles, are treated with print pastes according to one or more of claims 28-31 or 35.

37. Textiles which have been treated with the print pastes according to one or more of claims 28-31 or 35.
